(19) United States
(12) Patent Application Publication
(10) Pub. No.: US 2015/0135704 A1
(43) Pub. Date: May 21, 2015

(54) BRAKE FLUID RESERVOIR WITH PRESSURE BALANCING

(71) Applicant: Robert Bosch GmbH, Stuttgart (DE)

(72) Inventors: Vincent Maury, La Plaine St. Denis (FR); Jean-Michel L'aot, Stains (FR); Sylvain Lenczner, Esbly (FR)

(21) Appl. No.: 14/403,238

(22) PCT Filed: May 22, 2013
(86) PCT No.: PCT/EP2013/060478

§ 371 Date: Nov. 24, 2014

(30) Foreign Application Priority Data
May 23, 2012 (FR) 1254714

(51) Int. Cl. B60T 11/26

(52) U.S. Cl. CPC B60T 11/26
USPC 60/584; 220/203.28; 60/585

(57) ABSTRACT

A brake fluid reservoir includes in its upper portion a bottleneck with a thread and a top for receiving a cap with an edge and a top. The top of the bottleneck has channel opens into the atmosphere, one end of the channel leading into the atmosphere, one end of the channel leading into the interior of the bottleneck and the other end communicating with the outside atmosphere via a cavity.

### FIELD OF THE INVENTION

The present invention concerns a brake fluid reservoir with an air vent for pressure balancing, the top of the reservoir body being equipped with a threaded neck accommodating a threaded cap on the neck and having a baffled passageway for venting the reservoir.

### BACKGROUND INFORMATION

The realization of brake fluid reservoirs with pressure balancing is known. There exist different embodiments of reservoirs wherein the cap has an element forming a baffle enabling the pressure to be balanced while preventing brake fluid from escaping due to the effect of the vehicle's sudden acceleration or deceleration, for example, if the brakes are applied suddenly. These solutions are not always satisfactory, however, because the risk of the fluid escaping remains due to the orientation of the baffle, which can be incorrectly oriented with respect to the vehicle axis.

Document EP 2,189,344 discusses a brake fluid reservoir equipped with a pressure balancing arrangement, thereby avoiding the risk of brake fluid escaping under exceptional conditions through the particular orientation of the outlet of the cap by indexing the seal forming the baffle equipping the interior of the cap. This seal is positioned precisely so that the cap, once screwed into place, is suitably oriented and so that the outlet of the baffle is not turned toward the front, an orientation that would be the most favorable for the escape of brake fluid from the baffle through the effect of sudden braking.

But this solution, although interesting, has the disadvantage of being complex to realize given that the cap consists of the cap body in the form of a lid with an indexed thread and accommodates the seal forming a baffle, which is itself indexed, by a connecting arrangement that respects the indexing. Finally, a gasket is placed between the cap equipped with its baffle and the top of the neck. The neck must also have an indexed thread so that, when the cap is screwed in place, the baffle will have the correct orientation.

This solution has the disadvantage of complex manufacture and additional assembly operations resulting in relatively high costs overall.

### SUMMARY OF THE INVENTION

An object of the present invention is the realization of a brake fluid reservoir with pressure balancing that is especially simple to produce and use, so as to reduce the cost of the reservoir and ensure the efficiency of the pressure balancing while avoiding the risk of brake fluid escaping.

To that end, an object of the invention is a brake fluid reservoir of the type described above, characterized in that,

A) the neck has a top with a pressure balancing channel,
open on top,
having a first extremity forming an entrance communicating with the interior of the reservoir and a second extremity forming an outlet communicating with the surrounding atmosphere,
occupying at least one portion of the periphery of the top of the neck,
this channel, situated on the interior of the neck, being surrounded on the exterior by a sealing surface,

B) the cap consists of:
a peripheral edge equipped with internal threading corresponding to the external threading on the neck, and
a flat bottom that engages with the top of the neck when the cap is screwed on,
an annular contact surface between the sealing lip and the edge of the cap, this surface being equipped with an opening straddling the outlet region of the channel to constitute the outlet of the channel when the cap is screwed onto the neck.

The reservoir according to the invention has the advantage of having a one-piece cap incorporating the air vent portion. Likewise, the top of the neck incorporates the channel forming the baffle in such a way that realization of the assembly is especially simple. Use is also simple and the cap can be very easily placed in the appropriate position not only to enable communication between the interior of the brake fluid reservoir and the exterior and balance the pressure to avoid any vacuum in the reservoir even in the event of significant and rapid extraction of brake fluid during braking, but also ensuring that there is no risk that the liquid shaken in the reservoir will escape through the balancing path formed by the channel specifically during a sudden braking action.

According to an advantageous characteristic, the entrance of the channel is a lateral entrance crossing the partition bordering the channel on the interior.

This lateral entrance is realized very simply with a mold without requiring any moving parts because this lateral entrance is open on top.

According to another advantageous characteristic, the channel occupies almost the entire periphery of the upper portion of the neck and is circular in shape, its inlet being separated from its outlet by a partition.

This circular embodiment of the channel is particularly simple because the channel is circular in shape and the inlet and outlet in the channel are simply separated by a partition, the inlet emerging in the reservoir laterally through removal of a portion of the wall, whereas the outlet communicates from above.

According to another advantageous characteristic, the pressure balancing channel makes more than one peripheral turn in the upper portion of the neck.

According to another advantageous characteristic, the flat bottom has a circular sealing lip occupying a position corresponding to the opening of the neck when the cap is screwed onto the neck so that the circular sealing lip inside the neck engages with the partition bordering the channel on the interior.

This sealing lip completes the seal of the channel over the entire periphery without interfering with the opening of the entrance to the channel, which can pass beneath the lip. This lip ensures the effectiveness of the pressure balancing path consisting of the channel once the cap is screwed onto the neck.

According to another advantageous characteristic, the outlet is an opening in the shape of a cavity communicating with the threaded region of the cap and that of the neck.

According to another advantageous characteristic, the upper portion of the neck has, upon its outer surface, an orientation marker for determining the screw position of the cap.

The present invention will be described in greater detail by an example of a brake fluid reservoir with pressure balancing, shown schematically in the attached drawings.

### BRIEF DESCRIPTION OF THE DRAWINGS

FIG. 1 is an isometric view of the top of the reservoir limited to the neck and cap cut by a diametral plane.

FIG. 2 is an isometric view of the neck of the reservoir.

FIG. 3 is an isometric view of the neck with the cap cut by a diametral plane and screwed onto the neck.

FIG. 4 is a bottom view of the cap.

### DETAILED DESCRIPTION

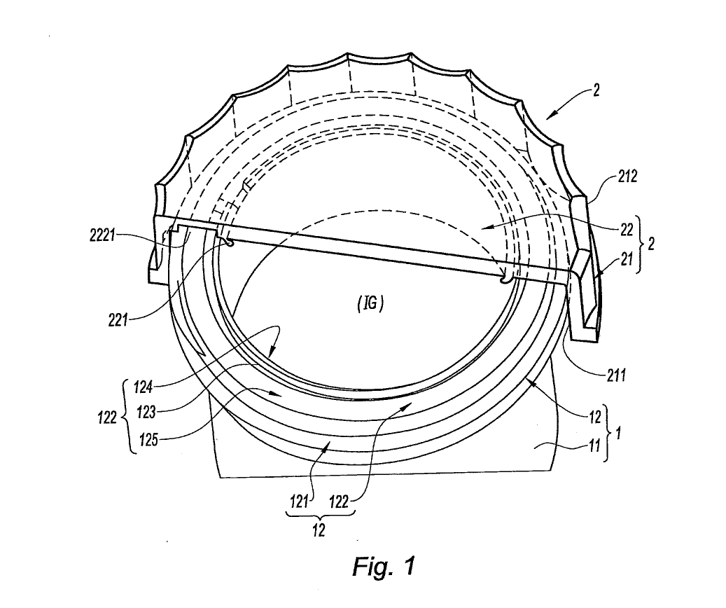

According to FIG. 1, brake fluid reservoir 1, shown very partially, has top 11, equipped with a threaded neck 12, closed by screw cap 2, so the reservoir can be filled while ensuring that the pressure is balanced inside the reservoir. The balancing must occur rapidly during operation of the brake system in the event of the rapid removal of brake fluid for this pressure to be at atmospheric pressure, preventing the creation of a pressure drop that would block the extraction of brake fluid by the master cylinder supplied by reservoir 1.

Cap 2 has edge 21 with interior threads, 211 corresponding to threads 121 of neck 12 and bottom 22. On the outside, cap 2 is equipped with portions in relief, 212, to facilitate gripping it when tightening or loosening.

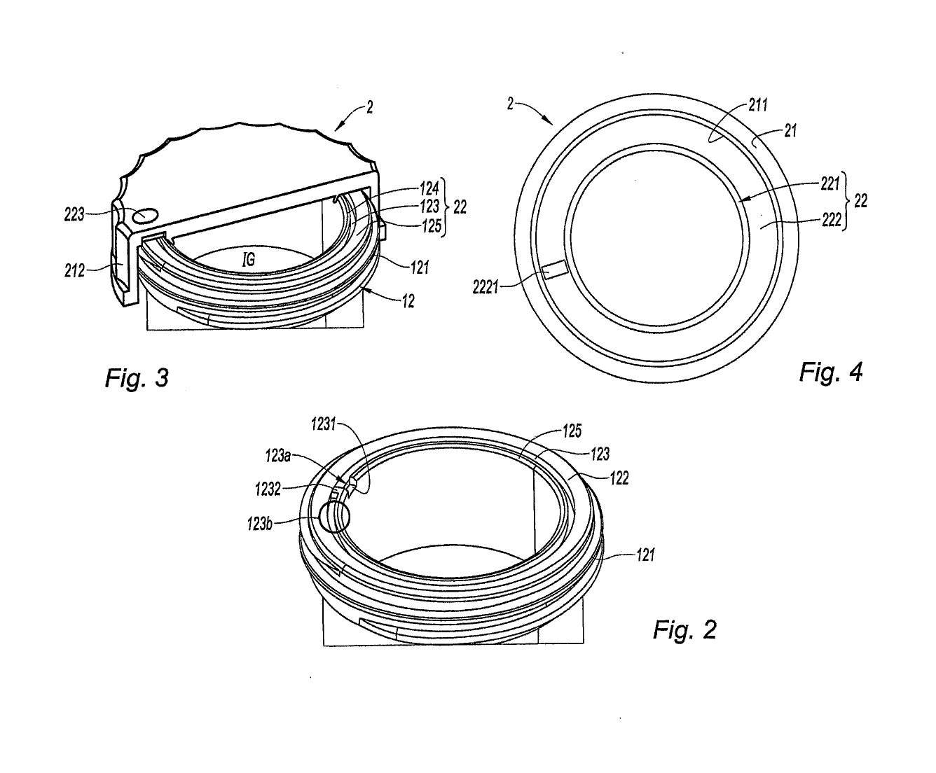

According to FIG. 2, neck 12 has, beyond exterior threads 121, upper portion 122 having, on the inside (IG) of the neck, balancing channel 123 that is open on top. This balancing channel, 123, recessed into upper portion 122, there occupies a significant portion of the periphery. In this embodiment, channel 123 occupies almost the entire periphery. It is bordered, on the inside (IG) by partition 124 and on the outside of the neck by annular sealing surface 125.

As shown in FIG. 2, channel 123 has first extremity 123a with an inlet consisting of notch 1231 in interior partition 124 and second extremity 123b, corresponding to the outlet or outlet region 123b. Channel 123, which almost entirely occupies the periphery of top 122 of neck 12, separates its inlet 123a and its outlet region 123b with partition 1232 in such a way that inlet 123a of channel 123 and its outlet 123b are unable to communicate directly. Communication between inlet 123a and outlet 123b occurs solely through channel 123 when cap 2 is screwed in place.

As shown in FIGS. 1, 3, 4, cap 2, in the shape of a top, has peripheral edge 21, whose interior surface is provided with threads 212 for screwing to threads 121 of neck 12 and flat bottom 22 (FIG. 4), from which circular sealing lip 221 extends. The geometry of this circular lip 221 is such that whenever cap 2 is screwed to neck 12, it enters the neck and is applied to interior partition 124 bordering channel 123. Beyond lip 221, bottom 22 is flat and forms an annular contact surface 222 intended to surmount upper portion 122 of neck 12, including channel 123 and partition 124, in such a way as to create a pressure balancing conduit between inlet 123a of channel 123 and its outlet 123b.

Annular contact surface 222 is equipped with cavity-shaped opening 2221, which crosses this surface 222, for example, in a radial direction so that, when cap 2 is screwed onto neck 12, opening 2221 straddles channel 123, thereby constituting the outlet of the channel.

Cap 2 is screwed in such a way that its opening 2221 encounters outlet region 123b of channel 123. On the exterior, cap 2 has marker 223, indicating open position 2221, so it can be positioned by screwing it to the appropriate location.

Cap 2 can also be indexed by the configuration of its threads 211 and those 121 of neck 12 so that, when it is completely screwed in place, opening 2221 of cap 2 is found in outlet region 123b of the channel.

Cap 2 being screwed on neck 12 forms, with channel 123, a communication path with a very narrow cross-section, therefore with a significant pressure drop between the channel inlet and its outlet, which enables pressure to be balanced inside reservoir 1 to bring it to atmospheric pressure while preventing brake fluid from escaping from the reservoir through cap 2.

Depending on the installation position of reservoir 1 in the engine compartment, cap 2 will be oriented in the most suitable manner to prevent the sudden movement of brake fluid in the reservoir, for example, during sudden braking, from being pushed through the channel to the outlet. The outlet is oriented toward the back, which corresponds to the position toward which there is the least risk of brake fluid being pushed or being pushed violently and being forced through the channel and leaking through the cap.

According to a variant not shown, channel 123, which, in the above example, occupies almost the entire periphery of upper portion 122 of the neck, can also be shorter in length and occupy only a fraction of that periphery or have a length that extends over more than one turn in the top of the neck. In this case, cavity shaped opening 2221 straddles only the outlet region of this channel without straddling another portion of the channel in such a way that the communication path between the reservoir inlet and outlet for balancing extends over the entire length of the channel.

The brake fluid reservoir and its cap are made simply of molded plastic material. The shape of the neck as well as the cap allow for very simple manufacture without requiring a complex mold and moving elements.

### REFERENCE KEY

1 brake fluid reservoir
11 top of reservoir
12 threaded neck of reservoir
121 neck threads
122 top of neck
123 channel
123a first extremity of channel
123b second extremity of channel
1231 notch of first extremity 123a of the channel
1232 partition of second extremity 123b of the channel
124 interior partition delimiting channel 123
125 annular sealing surface
2 cap
21 edge
211 threads
212 raised part
22 bottom of cap
221 sealing lip
222 annular contact surface
2221 cavity shaped opening
223 marker
IG interior of neck 12

1-7. (canceled)

8. A brake fluid reservoir with an air vent for pressure balancing, comprising:
a reservoir body; and
a threaded neck, at a top of the reservoir body, accommodating a threaded cap screwed to the neck and having a baffled passage for venting the reservoir;
wherein the neck has a top with a pressure balancing channel which is open on top, having a first extremity forming an entrance communicating with the interior of the reservoir body and a second extremity forming an outlet communicating with the surrounding atmosphere, occupying at least one portion of the periphery of the top of the neck, the channel situated on the interior of the neck being surrounded on the exterior by a sealing surface, and
wherein the cap includes a peripheral edge having internal threading corresponding to the external threading on the neck, a flat bottom that engages with the top of the neck when the cap is screwed, and an annular contact surface between the sealing lip and the edge of the cap, this surface being equipped with an opening straddling the outlet region of the channel to constitute the outlet of the channel when the cap is screwed onto the neck.

9. The brake fluid reservoir of claim 8, wherein the inlet of the channel is a lateral inlet crossing the partition bordering the channel on the interior.

10. The brake fluid reservoir of claim 8, wherein the channel occupies practically the entire periphery of the top of the neck and is circular in shape, its inlet being separated from its outlet by a partition.

11. The brake fluid reservoir of claim 8, wherein the pressure balancing channel makes more than one peripheral revolution on the top of the neck.

12. The brake fluid reservoir of claim 8, wherein the flat bottom has a circular sealing lip occupying a position corresponding to the opening of the neck when the cap is screwed onto the neck so that the circular sealing lip in the neck engages with the partition bordering the channel on the interior.

13. The brake fluid reservoir of claim 8, wherein the opening in the shape of a cavity communicates with the threaded region of the cap and that of the neck.

14. The brake fluid reservoir of claim 8, wherein the outer face of the top of the cap has an orientation marker enabling the screw position of the cap to be determined.
